(19) United States
(12) Patent Application Publication
(10) Pub. No.: US 2004/0246430 A1
(43) Pub. Date: Dec. 9, 2004

(54) Method for curing sealant of a liquid crystal display with peripheral circuits

(76) Inventor: Po-Hsiu Shih, Chung Ho City (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/857,933

(22) Filed: Jun. 2, 2004

(30) Foreign Application Priority Data
Jun. 9, 2003 (TW) 92115585

(51) Int. Cl. G02F 1/1339

(52) U.S. Cl. 349/153

(57) ABSTRACT

A method for curing sealant of a liquid crystal display and peripheral circuits thereof are described. In the method, a first glass substrate and a second glass substrate are first provided. A black matrix is formed on the first glass substrate and peripheral circuits are formed on the second glass substrate. A sealant, which is a light-cured sealant, adheres the first glass substrate to the second glass substrate. The peripheral circuits further include a hollow area to allow a light radiating from the second glass substrate through the hollow area to the sealant so as to increase light exposure of the sealant. A liquid crystal display sealant curing apparatus is utilized to accomplish the method for curing sealant of a liquid crystal display. The apparatus includes a first light-generating device disposed above the liquid crystal display and/or simultaneously includes a second light-generating device disposed under the liquid crystal display.

### FIELD OF THE INVENTION

The present invention relates to a method for curing sealant of a liquid crystal display, and especially, to peripheral circuits of a liquid crystal display to improve the sealant hardening efficiency for the liquid crystal display.

### BACKGROUND OF THE INVENTION

Recently, liquid crystal displays (LCD) have been widely applied in electrical products, due to the rapid progress of optical technology and semiconductor technology. Moreover, with the advantages of high image quality, compact size, light weight, low driving voltage, and low power consumption, LCDs have been introduced into portable computers, personal digital assistants, color televisions, and gradually replaced the cathode ray tubes (CRT) used for conventional displays. LCDs are becoming a mainstream display apparatus.

The main part of an LCD is a liquid crystal (LC) unit composed of two parallel transparent substrates with LC sealed therein. The main trend in LCDs is the thin film transistor (TFT) LCD. The fabrication processes of a TFT-LCD can be divided into four parts: TFT array process, color filter (CF) process, LC cell assembly process, liquid crystal module (LCM) process.

The TFT array process is used to fabricate a TFT substrate. Each TFT respectively aligns with one pixel electrode. The CF process is used to fabricate a color filter substrate. A color filter layer composed of different color filter sheets is located on the color filter substrate, and a black matrix layer surrounds each color filter sheet. The black matrix layer is utilized to cover the TFT array, metal lines connecting different TFTs and peripheral circuits close to the display area.

The LC cell assembly process is used to parallel-assemble TFT substrate and CF substrate. Bead spacers are spread between the TFT substrate and the CF substrate to maintain a fixed distance, i.e. a cell gap, therebetween. LC is injected into the cell gap and then the injection opening is sealed.

Conventional LC injection is a complicated procedure in the TFT-LCD fabrication process. The one drop fill (ODF) process can simplify the fabrication processes. In the ODF process, an ultraviolet-type sealant is used to seal the TFT substrate and the CF substrate. In practical fabrication process, the ultraviolet-type sealant may pollute the liquid crystal if the ultraviolet-type sealant is not cured very well. Therefore, the yield rate and the quality of the liquid crystal display are reduced and a manufacturing bottleneck is generated.

### SUMMARY OF THE INVENTION

It is an object of the present invention to provide a method for curing sealant of a liquid crystal display to improve the hardening result of the sealant.

It is another object of the present invention is to provide a method for curing sealant of a liquid crystal display to prevent sealant pollution of liquid crystal.

It is yet another object of the present invention is to provide improved peripheral circuits to increase the amount of light exposure on the sealant.

It is still another object of the present invention is to provide a sealant curing apparatus to enhance the hardening status of the sealant.

To accomplish the above objectives, the present invention provides a method for curing sealant of a liquid crystal display. The method includes the following steps. A first glass substrate is provided and a black matrix is formed thereon. A second glass substrate is provided and circuits are formed thereon. The circuits further include a first hollow area. The hollow area is a transparent area formed by transparent material and the metal circuits bypass the hollow area. The first glass substrate and the second glass substrate are sealed with a sealant. The sealant is an ultraviolet-type sealant, a laser-type sealant or an infrared-type sealant.

Subsequently, the sealant is cured by light corresponding to the type of sealant. A first incident light hardens the sealant from the first glass substrate and the second incident light hardens the sealant from the second glass substrate through the first hollow area.

The first glass substrate is a color filter substrate and the second glass substrate is a thin film transistor substrate. The first hollow area is preferably under a partial sealant, covered by the black matrix, of the sealant. The first hollow further comprises a plurality of interlaced openings and a plurality of interlaced segments.

The second incident light is constructed by a reflected light of the first incident light such where, for example, the first incident light is reflected by a mirror surface under the second glass substrate to form the second incident light. The circuits can further include a second hollow area to transmit the first incident light through the second hollow area whereupon the first incident light is reflected by the mirror surface. The reflected first incident light becomes the second incident light to expose the sealant by way of the first hollow area so as to harden the sealant.

The second incident light can be also generated by a light-generating device inside a support bench to expose the sealant to the through the first hollow area. Otherwise, the method for curing sealant of a liquid crystal display according to the present invention can also be achieved to reverse the liquid crystal display after the sealant is exposed to the first incident light. Subsequently, the first incident light transmits through the first hollow area to form the second incident light so as to harden the sealant.

In another aspect, the present invention provides a liquid crystal display. The liquid crystal display includes a thin film transistor substrate, circuits, a color filter substrate, a black matrix, and a sealant.

The sealant adheres the thin film transistor substrate to the color filter substrate. The circuits further includes a first hollow area under a part, covered by the black matrix, of the sealant to expose the sealant to a second incident light transmitted through the first hollow area. A first incident light directly hardens the sealant from the color filter substrate above the liquid crystal display.

In still another aspect, the present invention provides a liquid crystal display sealant curing apparatus. The liquid crystal display sealant curing apparatus includes a first light-generating device above the liquid crystal display to harden the sealant with a first predetermined angle and a second light-generating device under the liquid crystal display to harden the sealant with a second predetermined angle. The liquid crystal display further includes a first hollow area under a part, covered by the black matrix, of the sealant to expose the sealant to a second incident light transmitted through the first hollow area.

The first predetermined angle and/or the second predetermined angle are about 15 to 60 degrees to a normal direction of the color filter substrate, preferably about 30 to 45 degrees, and optimally about 30 degrees or about 45 degrees.

The method for curing sealant of a liquid crystal display of the present invention can effectively increase the hardening quality of the sealant and the quality and yield rate of the liquid crystal display can therefore be increased. The present invention also provides the circuit layout and the sealant curing apparatus for hardening the sealant.

### BRIEF DESCRIPTION OF THE DRAWINGS

The foregoing aspects and many of the attendant advantages of this invention are more readily appreciated as the same becomes better understood by reference to the following detailed description, when taken in conjunction with the accompanying drawings, wherein:

FIG. 1 is a schematic, cross-sectional view of a first preferred embodiment for illustrating the method for curing sealant of a liquid crystal display according to the present invention;

FIG. 2 is a schematic, cross-sectional view of a second preferred embodiment for illustrating the method for curing sealant of a liquid crystal display according to the present invention;

FIG. 3 is a schematic, cross-sectional view of a third preferred embodiment for illustrating the method for curing sealant of a liquid crystal display according to the present invention; and

FIG. 4 is a schematic, cross-sectional view of a fourth preferred embodiment for illustrating the method for curing sealant of a liquid crystal display according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

FIG. 1 is a schematic, cross-sectional view of a first preferred embodiment for illustrating the method for curing sealant of a liquid crystal display according to the present invention. A liquid crystal display includes an upper substrate 100, a lower substrate 110, a black matrix 170, circuits 180, and sealant 140. The sealant 140 seals a gap 130 between the upper substrate 100 and the lower substrate 110 around the liquid crystal display so that the liquid crystal can be sealed up therein. The gap 130 is about 3-5 microns.

Generally, the upper substrate 100 is a color filter (CF) substrate and the lower substrate 110 is a thin film transistor (TFT) substrate. The sealant 140 is preferably an ultraviolet-type sealant. However, the upper substrate 100 and the lower substrate 110 can be also in a reverse manufacture direction. The sealant 140 can be any kind sealant material hardened by light, such as, for example, a laser-type sealant, an infrared-type sealant or a visible light-type sealant.

The method for curing sealant of a liquid crystal display of the liquid crystal display according to the present invention uses a new design for the circuits 180 that provides the sealant with greater light exposure to harden the sealant well, and the light corresponds to the type of the sealant. The present invention further utilizes a curing apparatus with a support bench 120 to harden the sealant 140 with more light exposure.

The support bench 120 has a mirror surface that provides almost total reflection to reflect most of the energy of incident light 150 to the sealant 140 so as to increase the light exposure of the sealant 140.

The support bench 120 for the method for curing sealant of a liquid crystal display according to the present invention can also use a table having therein a light-generating device, such as a lamp, and the liquid crystal display is disposed on the table to harden the sealant with additional light from the light-generating device of the table so as to increase the light exposure of the sealant 140.

Furthermore, the support bench 120 can combine the mirror surface and the light-generating device to expose the sealant 140 with additional light reflected and generated by the support bench 120 to increase the light exposure of the sealant 140.

The method for curing sealant of a liquid crystal display according to the present invention can also expose the sealant 140 of the liquid crystal display via the upper substrate 100 and then reverse the liquid crystal display to expose the sealant 140 to light via the lower substrate 120. Therefore, the method for curing sealant of a liquid crystal display is not limited by the support bench 120 of the sealant curing apparatus.

A detailed description describes the new design of circuits 180 of the liquid crystal display and how to increase light exposure of the sealant 140. Referring to FIG. 1 again, a partial sealant of the sealant 140 and black matrix 170 are overlapped. Therefore, the partial sealant covered by the black matrix 170 is difficult to cure by the incident light 150 from the upper substrate 100 because the partial sealant covered by the black matrix 170 is not directly exposed to the incident light 150 from the upper substrate 100. Hence, the partial sealant needs more time to be hardened; otherwise the partial sealant is not hardened well and can pollute the liquid crystal.

The circuits 180 of the liquid crystal display include a hollow area 160 in the lower substrate 110 and the hollow area 160 is under the sealant. Therefore, the incident light 150 can reach the mirror surface of the support bench 120 and then is reflected by the mirror surface of the support bench 120 so that the partial sealant is exposed to the reflected incident light 150. The partial sealant can also be exposed to another light generated by a light-generating device, such as a lamp, inside the support bench 120. However, the partial sealant can also be hardened with the incident light 150 from the upper substrate 100 and then with the incident light 150 from the lower substrate 110 by reversing the liquid crystal display.

A incident angle of the incident light 150 is about 15 to 60 degrees to the normal direction of the upper substrate 100, is preferably about 30 to 45 degrees, and is optimally about 30 degrees or about 45 degrees to expose efficiently the sealant 140 to the incident light 150 and the reflected incident light 150. In particular, the hollow areas 160 and the circuits 180 are designed more conveniently when the incident angle is about 30 degrees or about 45 degrees.

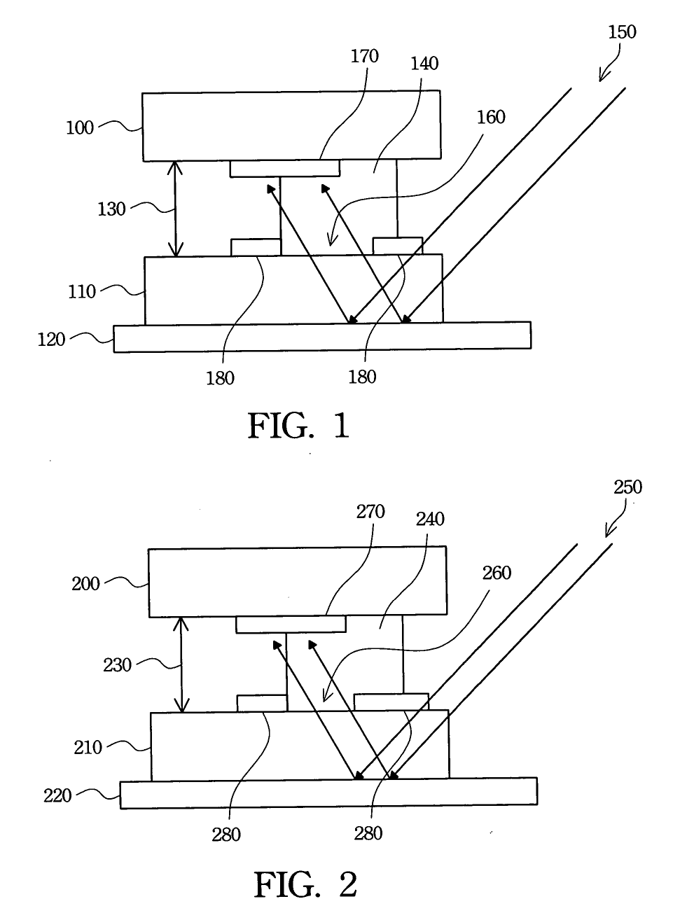

FIG. 2 is a schematic, cross-sectional view of a second preferred embodiment for illustrating the method for curing sealant of a liquid crystal display according to the present invention. The liquid crystal display includes an upper substrate 200, a lower substrate 210, a black matrix 270, circuits 280, and a sealant 240. The sealant 240 seals a gap 230 between the upper substrate 200 and the lower substrate 210 to isolate the liquid crystal therein. The second preferred embodiment illustrates the circuits 280 on the lower substrate 210 to form a suitable hollow area 260 thereon when the hollow area 260 is smaller than the hollow area 160 of FIG. 1 due to limitations on the layout of circuits 280. Therefore, the method for curing sealant of a liquid crystal display according to the present invention can still achieve the advantage of increasing the light exposure of the sealant 240 if the hollow area 260 can be suitably disposed under the black matrix 270; e.g., the hollow area 260 is directly under a partial sealant, covered by the black matrix 270, of the sealant 240.

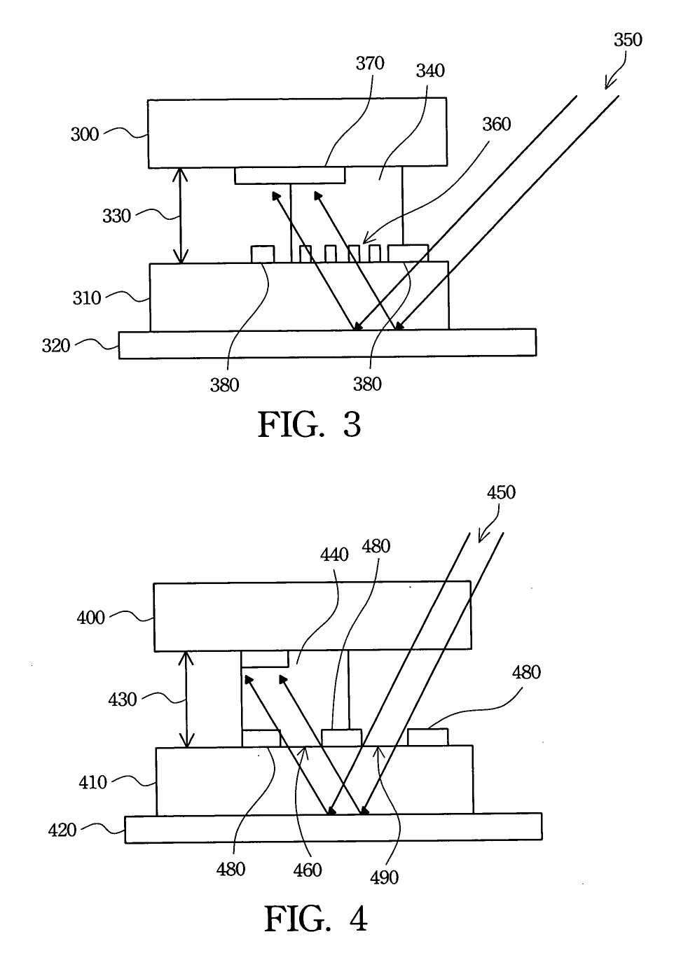

FIG. 3 is a schematic, cross-sectional view of a third preferred embodiment for illustrating the method for curing sealant of a liquid crystal display according to the present invention. The liquid crystal display has an upper substrate 300, a lower substrate 310, a black matrix 370, circuits 380, and a sealant 340. The sealant 340 seals a gap 330 between the upper substrate 300 and the lower substrate 310 around the liquid crystal display to isolate the liquid crystal therein. The third preferred embodiment is particular to utilization on the circuits 380 which cannot be formed with an entire hollow area as the hollow area 160 of FIG. 1 or the hollow area 260 of FIG. 2. A hollow area 360 is formed with interlaced openings for transmitting reflected incident light 350 and interlaced segments for laying out the circuits 380. The reflected incident light 350 can efficiently transmit through the hollow area 360 with interlaced openings and irradiate the sealant 340. Therefore, the hollow area 360 with interlaced openings can also efficiently increase the light exposure amount on the sealant 340. The hollow area 360 preferably occupies at least 50% of the area of a partial sealant, covered by the black matrix 370, of the sealant 340.

FIG. 4 is a schematic, cross-sectional view of a fourth preferred embodiment for illustrating the method for curing sealant of a liquid crystal display according to the present invention. In the fourth preferred embodiment, the liquid crystal display has an upper substrate 400, a lower substrate 410, a black matrix 470, circuits 480, and a sealant 440. The sealant 440 seals a gap 430 between the upper substrate 400 and the lower substrate 410 around the liquid crystal display to isolate the liquid crystal therein. The fourth preferred embodiment is particular to utilization on the circuits 480 which have complicated peripheral circuits 480 beyond the sealant 440 around the liquid crystal display. Therefore, the incident light 450 cannot directly transmit through the lower substrate 410 and then reflect to the sealant 440. Hence, the circuits 480 are preferably designed to have a first hollow area 460 and a second hollow area 490 so that the incident light 450 can transmit through the second hollow area 490, reach the mirror surface of the support bench 420, and then reflect to the sealant 440 via the first hollow area 460. Accordingly, the light exposure amount of the sealant 440 can be also efficiently increased.

In this preferred embodiment, the sealant 440 can be cured better if the support bench 420 has a light-generating device to generate a second light to cure the sealant 440 and design of the circuits 480 can also be simplified.

The method for curing sealant of a liquid crystal display of the liquid crystal display according to the present invention can effectively harden the sealant so as to increase quality and yield rate of the liquid crystal display. With some practical experiments, the method for curing sealant of a liquid crystal display according to the present invention can distinctly and effectively improve the quality of the sealant. Therefore, the method for curing sealant of a liquid crystal display according to the present provides an apparent improvement in the manufacture of the liquid crystal display.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A method for curing sealant of a liquid crystal display, the method comprising:
providing a first glass substrate;
forming a black matrix on the first glass substrate;
forming a second glass substrate;
forming circuits on the second glass substrate, wherein the circuits comprise a first hollow area;
adhering the first glass substrate to the second glass substrate with a seal;
curing the sealant with a first incident light from the first glass substrate; and
curing the sealant with a second incident light from the second glass substrate side via the first hollow area.

2. The method of claim 1, wherein the first glass substrate is a color filter substrate.

3. The method of claim 1, wherein the second glass substrate is a thin film transistor substrate.

4. The method of claim 1, wherein the first hollow area is under a partial sealant, covered by the black matrix, of the sealant.

5. The method of claim 1, wherein the first hollow further comprises a plurality of interlaced openings and a plurality of interlaced segments.

6. The method of claim 1, wherein the sealant is an ultraviolet-type sealant.

7. The method of claim 1, wherein the sealant is a laser-type sealant.

8. The method of claim 1, wherein the sealant is an infrared-type sealant.

9. The method of claim 1, wherein the first incident light is reflected to form the second incident light.

10. The method of claim 9, wherein the circuits further comprise a second hollow area, the first incident light transmits through the second hollow area and then is reflected to form the second incident light, and the second incident light transmits through the first hollow area to harden the sealant.

11. The method of claim 1, wherein the first incident light is reflected by a mirror surface under the second glass substrate to form the second incident light.

12. The method of claim 1, wherein the second incident light is generated by a light-generating device inside a support bench to expose the sealant to the second incident light through the first hollow area.

13. The method of claim 1, wherein before the step of curing the sealant with a second incident light, further comprises a substrate-reversing step to reverse the liquid crystal display, and therefore the second incident light is formed by the first incident light transmitting through the first hollow area.

14. A liquid crystal display, comprising:
a thin film transistor substrate;
a circuits formed on the thin film transistor substrate;
a color filter substrate;
a black matrix formed under the color filter substrate and facing the circuits; and
a sealant adhering the thin film transistor substrate to the color filter substrate, wherein the circuits comprise a first hollow area under the sealant to expose the sealant to a second incident light transmitted through the first hollow area.

15. The liquid crystal display of claim 14, wherein the first hollow further comprises a plurality of interlaced openings and a plurality of segments.

16. The liquid crystal display of claim 14, wherein the sealant is an ultraviolet-type sealant.

17. The liquid crystal display of claim 14, wherein a first incident light from the color filter substrate is reflected by a support bench and forms the second incident light to harden the sealant.

18. The liquid crystal display of claim 14, wherein the support bench comprises a mirror surface to reflect the first incident light and form the second incident light.

19. The liquid crystal display of claim 18, wherein the circuits further comprise a second hollow area, the first incident light transmits through the second hollow area and then is reflected by the mirror surface to form the second incident light, and the second incident light transmits through the first hollow area to harden the sealant.

20. The liquid crystal display of claim 14, wherein the second incident light is generated by a light-generating device inside a support bench to harden the sealant through the first hollow area.

21. A liquid crystal display sealant curing apparatus for harden a sealant of a liquid crystal display, the liquid crystal display sealant curing apparatus comprising:
a first light-generating device above the liquid crystal display to harden the sealant with a first predetermined angle; and
a second light-generating device under the liquid crystal display to harden the sealant with a second predetermined angle

22. The liquid crystal display sealant curing apparatus of claim 21, wherein the liquid crystal display further comprises:
a thin film transistor substrate;
circuits formed on the thin film transistor substrate;
a color filter substrate; and
a black matrix formed under the color filter substrate and facing the circuits, wherein the thin film transistor substrate and the color filter substrate are adhered by a sealant and the circuits comprise a first hollow area under the sealant to expose the sealant to a second incident light transmitted through the first hollow area.

23. The liquid crystal display sealant curing apparatus of claim 22, wherein the second light-generating device is a mirror surface to reflect the first incident light and form the second incident light.

24. The liquid crystal display sealant curing apparatus of claim 22, wherein the second light-generating device is a lamp and generates the second incident light, and wherein the second incident light transmits through the first hollow area to harden the sealant under the thin film transistor substrate.

25. The liquid crystal display sealant curing apparatus of claim 22, wherein the first predetermined angle is about 15 to 60 degrees to a normal direction of the color filter substrate.

26. The liquid crystal display sealant curing apparatus of claim 25, wherein the first predetermined angle is about 30 to 45 degrees to the normal direction of the color filter substrate.

27. The liquid crystal display sealant curing apparatus of claim 26, wherein the first predetermined angle is about 30 degrees to the normal direction of the color filter substrate.

28. The liquid crystal display sealant curing apparatus of claim 22, wherein the second predetermined angle is about 15 to 60 degrees to a normal direction of the thin film transistor substrate.

29. The liquid crystal display sealant curing apparatus of claim 28, wherein the second predetermined angle is about 30 to 45 degrees to the normal direction of the thin film transistor substrate.

30. The liquid crystal display sealant curing apparatus of claim 29, wherein the second predetermined angle is about 30 degrees to the normal direction of the thin film transistor substrate.
